(19) United States
(12) Patent Application Publication
(10) Pub. No.: US 2009/0299909 A1
(43) Pub. Date: Dec. 3, 2009

(54) System and method for comprehensive management of company equity structures and related company documents with financial and human resource system integration

(76) Inventors: Andrew E. Levi, Plano, TX (US); Bradley W. Bauer, Richardson, TX (US); Robert C. Woldberg, Centerville, UT (US); Robert Kent Mansfield, Dallas, TX (US)

Correspondence Address: George R. Schultz;Schultz & Associates, P.C., One LincoIn Centre, Suite 1200, 54400 LBJ Freeway, Dallas, TX, 75240, US

(21) Appl. No.: 12/455,513

(22) Filed: Jun. 3, 2009

Related U.S. Application Data
(63) Continuation-in-part of application No. 10/980,615, filed on Nov. 3, 2004.
(60) Provisional application No. 60/517,166, filed on Nov. 4, 2003.

(51) Int. Cl. G06Q 40/00

(52) U.S. Cl. 705/36 R; 705/37

(57) ABSTRACT

A system comprises business logic operable for managing and administering company entities, records, documents, equity instruments, and stakeholders, a database storing data associated with the business logic, integration logic operable to integrate the business logic and its associated data with existing enterprise systems and data associated therewith, and a graphical user interface presenting a hierarchical tree view of the company entities, records, documents, equity instruments, and stakeholders.

### CROSS-REFERENCE TO RELATED APPLICATIONS

This application is a continuation-in-part of U.S. patent application Ser. No. 10/980,615 filed Nov. 3, 2004 entitled “System and Method for Comprehensive Management of Company Equity Structures and Related Company Documents with Financial and Human Resource System Integration” which claims the benefit of U.S. Provisional Application No. 60/517,166, filed Nov. 4, 2003.

### BACKGROUND

Corporations and other legal business formations such as partnerships and limited liability companies have historically used spreadsheet applications to track and manage the structure, relationships, and reporting of their stock, stock options, warrants, convertible debt, partnership interests, and membership units of stakeholders. In addition, these companies have used paper documents to manage and reference legal internal records and related agreements. Spreadsheets, by nature, are limited in their accuracy and functionality by their author. They also do not provide the capability to track accountability and change management. Spreadsheets also are not conducive to multi-user interaction, are unstructured and possess no inherent business logic on the subject matter.

With investment vehicles becoming increasingly more sophisticated, it is more difficult than ever to property track each structure and its respective rights and restrictions. Improperly tracking company records carries with it an enormous liability. Furthermore, actions performed against issuances or owned positions inherently have financial statement implications creating a chasm between the legal and accounting disciplines.

Paper recordkeeping carries with it its own set of problems. If records are lost, stolen, or destroyed, they are difficult or even impossible to re-create. With one set of official paper records, only one person can reference them at a time. Finally, there is no referential integrity between the paper documents and the equity issuances which are generated as a result of these paper records.

### BRIEF DESCRIPTION OF THE DRAWINGS

Aspects of the present disclosure are best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a system and method for comprehensive business entity records and equity instrument management with financial system integration;

FIG. 2 is a representative screen view of a graphical user interface;

FIG. 3 is a representative screen view of a new allocation rights and restrictions window;

FIG. 4 is a simplified flow diagram of an embodiment of a process for integration with the accounting and financial systems;

FIG. 5 is a simplified flow diagram of an embodiment of a process for managing the tracking of stakeholders;

FIG. 6 is a simplified flow diagram of an embodiment of a process for managing the tracking of employees;

FIG. 7 is a simplified flow diagram of an embodiment of a process for option expensing;

FIG. 8 is a simplified flow diagram of an embodiment of a process for managing security and authorizing access;

FIG. 9 is a simplified flow diagram of an embodiment of a process for introducing documents into the document management system;

FIG. 10 is a simplified flow diagram of an embodiment of a process for relating documents to objects and transactions;

FIG. 11 is a simplified flow diagram of an embodiment of a process for storing reports;

FIG. 12 is a simplified flow diagram of an embodiment of a process for issuance processing;

FIG. 13 is a simplified flow diagram of an embodiment of a process for analyzing liquidation proceeds; and

FIG. 14 is a simplified flow diagram of an embodiment of a process to analyze stakeholder voting rights.

### DETAILED DESCRIPTION

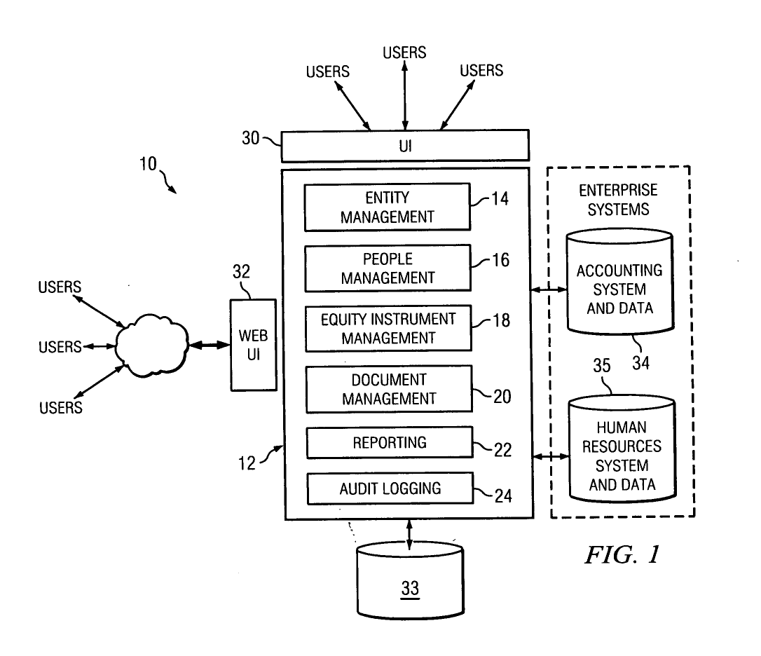

An easy-to-use system that gives users the ability to manage and administer company entities, records, documents, equity instruments, stakeholders is described herein. FIG. 1 is a simplified block diagram of an embodiment of a system and method 10 for managing comprehensive business entity records and equity instruments with financial system integration. System 10 includes complex business logic 12 that enable entity management 14, people management 16, equity instrument management 18, document management 20, reporting 22, and audit logging 24. In one embodiment, a relational database system may be used to implement business logic 12. These system components 14-24 are described in more detail below. System 10 further includes a user interface (UI) 30 and a web user interface or web portal 32 (for Internet and/or intranet access) that enable multiple users to access functions, documents, and data related to system 10. User interfaces 30 and 32 preferably provide a graphical interface that facilitates navigation between functions and access to data. System 10 further comprises a database 33 for storing data and documents. In particular, company documents such as articles of incorporation, partnership agreements, by-laws, board minutes, historic documents. Stock option plans, stock certificates, buy/sell agreements, contracts with company officers and board members, etc., may be stored in database 33 as binary records to ensure their integrity and security. The document management system of system 10 is integrated with other components of the system. For example, the Unsupported Issuance report is a report that shows all equity issuances that do not have proper documentation to support them.

System 10 is tightly integrated with existing enterprise systems such as accounting system and data 34 and human resources system and date 35. More specifically, system 10 is seamlessly integrated with the company chart of accounts, company master records, general ledger, tax tables, and employee records. System 10 may set up company entities by replicating general company information from accounting system 34, configure account correlations between the accounting system chart of accounts and the system's equity-specific accounts such as cash, common stock, treasury stock, dividends, payables, etc. Further, when a transaction occurs in system 10 that has general ledge implications, system 10 creates the proper journal entries directly in accounting system 34. As another example of integration with enterprise systems, when an employee stakeholder is terminated, the employee's equity positions are checked and resolved.

All changes to date associated with objects and transactions are logged by audit logging module 24. Recorded audit data may include transaction date/time, system user name, action type (insert, delete, update), transaction description, and transaction approval code (if applicable). These recorded data are related and group to a specific object (company, stakeholder, stock issuance, etc.) so that a report may be object-specific or encompass related child objects.

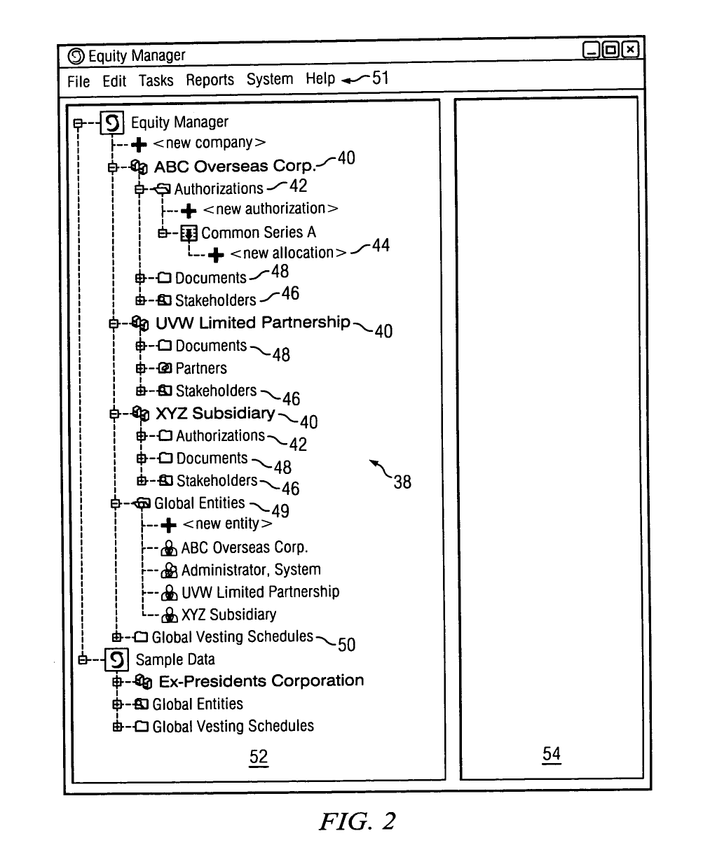

Referring to FIG. 2, a hierarchical graphical tree structure 38 may be used to represent and relate company entities 40, equity instrument authorizations 42, equity instrument allocations 44, stakeholders 46, company documents 48, etc. Each company entity 40 may be defined as a C corporation, S corporation, limited partnership (LP), limited liability partnership (LLP), limited liability company (LLC), and other company entity types. The hierarchical tree view shows the relationships between objects at different levels. When setting up a company entity in system 10, the user is prompted to enter data associated with the company entity, such as company name, type of organization, accounting method, company addresses, company contact information, state of organization, tax identifier, officers, directors, logo graphics, etc. An authorization 42 sets up the initial authority to allow an equity vehicle to exist so that it may be allocated and issued later. Authorization data categories include general information such as name, type, series, quantity, value, certificate prefix/suffix; rights and restrictions such as anti-dilution, preferences and priorities, voting rights conversions, class conversions, pre-emptive rights, and others; configuration of stock certificates; and configuration of accounts for proper journal entries. An allocation 44 represents a subset of the authorization that a company entity has set aside for a particular purpose, such as an initial round of funding, an employee stock option plan, or to reserve executive options for future issuance. Allocations reserve a defined allocation amount of an authorization to prevent over-issuance. No issuance can occur until an allocation is created.

In system 10, each company entity, when defined, is created as a company object according to object-oriented programming principles. An authorization 42 is created as a child object to a company object and may inherit characteristics or rules of the respective company object. An allocation 44 is created as a child object of an authorization object and may inherit characteristics or rules of the authorization object. Issuance objects (stock and option issuances) are created as child objects of an allocation object and inherit characteristics or rules of the allocation object. Rights and restrictions attributes each have a data locking capability that supports how rights and restrictions are administered at the authorization level, inherited by the allocation level, and then by each issuance. Locked rights and restrictions do not permit child objects to alter the inherited rule; unlocked rights and restrictions permits the unlocked elements to be changed in a child object. Object inheritance and locked/unlocked data elements are displayed to the users in a graphical manner such as using an easy-to-understand padlock icon to enable easy identification and modification.

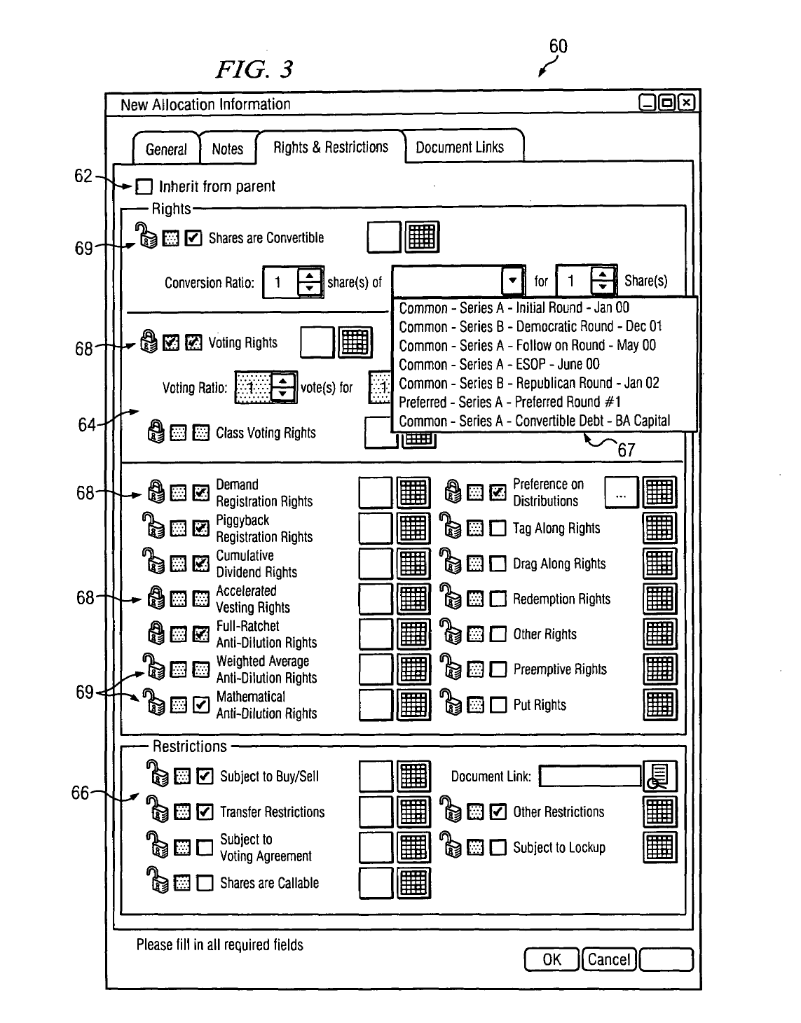

An example pop-up window 60 of new allocation rights and restrictions is shown in FIG. 3. A check box 62 is provided to enable the user to indicate with the new allocation is to inherit all the rights and restrictions from the parent object—the authorization object. If check box 62 is checked by the user, then all rights and restrictions check boxes 64 and 66 become dimmed or grayed-out to indicate that these data elements are to follow the parent object and cannot be modified. A drop-down list 67 may be used to display existing authorized equity vehicles for the user's selection. Further, each right and restriction may be locked or unlocked, as indicated by a padlock icon that, upon being clicked on by a user, changes its state from one state to the other, as indicated by a locked padlock icon 68 or an unlocked padlock icon 69.

Referring to FIG. 2 again, stakeholders 46 are global entities that have been associated with a company organization. Because a global entity is defined across the enterprise, duplications are avoided as each is subsequently added as a stakeholder to a different company organization in the system. System 10 may prompt the user to enter stakeholder name, address, contact information, employee, accredited designations, user identifier, security settings. The stakeholders that have been defined are placed in hierarchical tree graphics 38 under global entities 49 and also under the respective company entities 40 that they are associated with. Company documents 48 may also be accessed via hierarchical tree structure 38 under the respective company organizations. The company document folder enables users to view and print important company documents, such as articles of incorporation, partnership agreements, board minutes, by-laws, historic documents, stock option plans, employment agreements, etc. Further, these documents stored in documents folder 48 may be linked to one or more objects and transactions as supporting documents.

Hierarchical tree structure 38 displays entities 49 and global vesting schedules 50 in the same tree indentation level as the company entities 40. Global entities 49 may include people such as stockholders, partners, officers, directors, and employees, companies, and other entities that may apply across the enterprise to multiple company entities. Therefore, multiple company entities may share the same global entities, and the global entities need to be configured only once in the system and can therefore easily show cross-company ownership for each global entity. Global vesting schedules 50 are defined and structured vesting rules for stock, stock options, and/or warrants that have been defined and established for the company entities. The vesting schedule may define a one-time event, a recurring schedule, or a triggering event based on time or performance, and may define a vesting start date, vesting term, and vesting amount. The vesting schedules are defined globally so that future companies established in the system may have access to use the defined vesting schedules for their equity vehicles.

The graphical user interfaces may also provide a tool bar 51 with pull-down menus under general headings, such as “File”, “Edit”, “Tasks”, “Reports”, “System”, and “Help”. In general, the user interface comprises two window panes 52 and 54, where hierarchical tree structure 38 is displayed in window pane 52, and specific data related to one or more objects or data elements in the hierarchical tree selected by the user in window pane 52 are displayed in window pane 54.

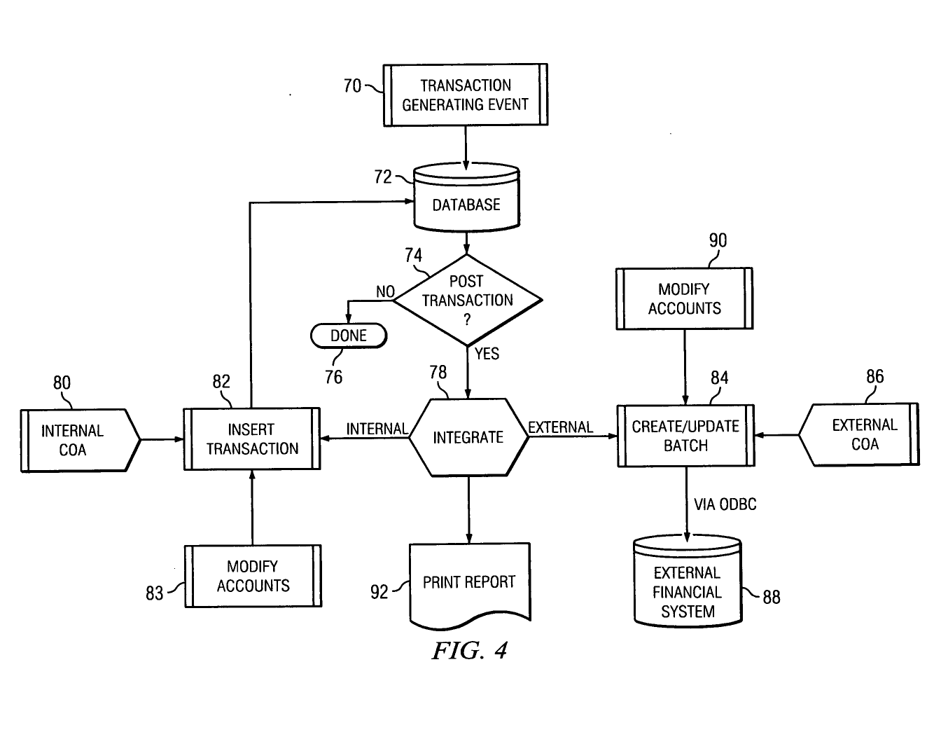

FIG. 4 is a simplified flow diagram of an embodiment of a process for integration with the accounting and financial systems. In block 70, an event occurs that triggers a journal entry in an existing financial system. Such events may include issuing stock, re-pricing stock, purchase stock, or expensing options. System integration points with an existing financial system may be in general ledger, human resources, financial reporting, asset management, debt management, workflow management, document management, for example. When the event occurs, the generated transaction and its associated journal entries are stored in the appropriate SQL tables in database 33 (FIG. 1), for example. If, at the time of the event, the user has indicated that they do not desire to post the transaction, then the process is completed, as shown in blocks 74-76. If the user indicates that the transaction should be posted, then the system determines whether internal or external integration was configured in block 78. With internal integration, the internal chart of accounts (COAs) may be set up to match the account names and account numbers of the external accounting system. In external integration the presentation and selection of the specific accounts from the chart of accounts occurs directly from the external accounting system. A chart of accounts is a list of an entity's accounts identified by an account name and an account number. The chart of accounts is the basis of the entity's general ledger system. If integration is internal, system 10 creates one or more virtual accounting entries using the internally set up and mapped accounts 80 and inserts the transaction entries in the database 82. As a part of creating the batch process, system 10 offers the user the ability to modify the accounts and amounts to be posted in block 83. If the integration is external, system 10 creates a batch process 84 for general ledger transactions or directly updates the SQL tables via published application program interfaces (APIs) of non-general ledger components. For batch updates, system 10 refers to the accounts in the system which have been mapped to corresponding accounts in external financial system 88 to determine to which accounts to post the transaction. As a part of creating the batch, system 10 offers the user the ability to modify the accounts and amounts in block 90 prior to posting the transaction to the external financial system. The user may also choose to print the transaction, which generates and prints a report with the corresponding accounting entry in block 92 which may then be entered manually into a non-integrated accounting system.

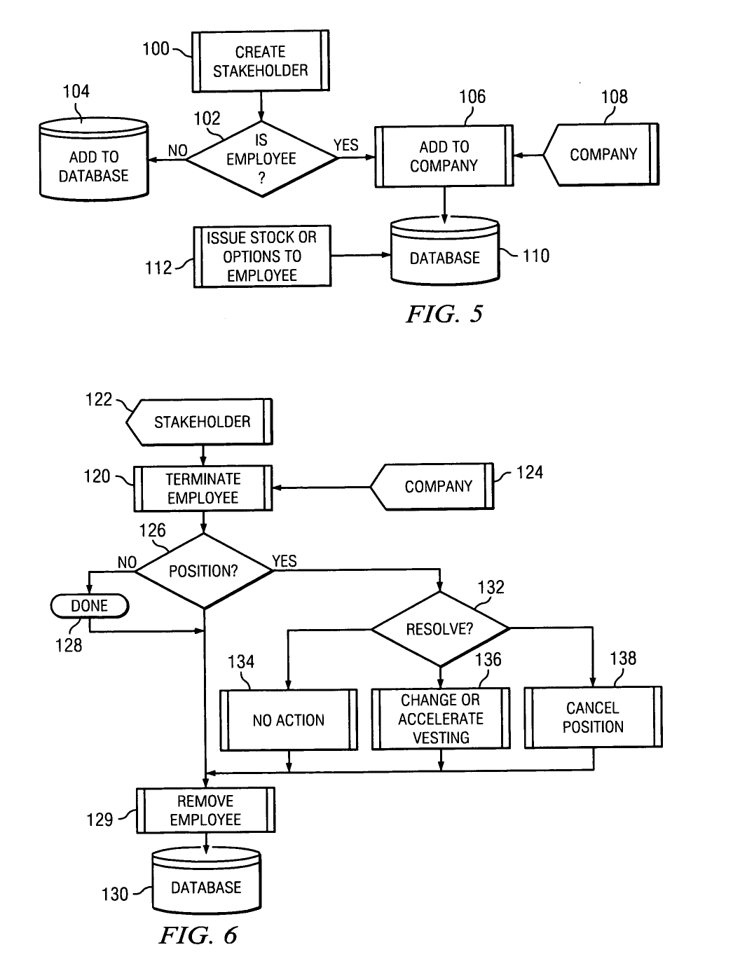

FIG. 5 is a simplified flow diagram of an embodiment of a process for managing the tracking of stakeholders. In block 100, a stakeholder is created and configured. A stakeholder creation may originate in an existing enterprise human resource system 35 (FIG. 1). For example, the enterprise human resources system may pass an employee identifier and other data (name, address, hire date, etc.) to system 10 when a new employee/stakeholder is added to the human resources system. If a configured stakeholder is not an employee of a defined company in system 10, as determined block 102, the stakeholder is added to the database in block 104. If the configured stakeholder is an employee of a defined company entity, then the stakeholder may be added to the company entity in block 106. This may be accomplished by choosing the company to add the stakeholder to from a configuration dialog window in block 108. Once the stakeholder is added to the company, database 110 (database 33 in FIG. 1) is updated with data associated with the added stakeholder. Stock or options may be created and issued to the defined stakeholder whether the stakeholder is configured as an employee of a company or not.

FIG. 6 is a simplified flow diagram of an embodiment of a process for managing the tracking of employees in the event of an employee termination. Similarly, employee termination may be an event that originates at the enterprise human resources system 35 (FIG. 1) by passing an employee identifier to system 10. When a configured employee stakeholder is to be terminated from a configured company entity 120, the user may choose to terminate at either the stakeholder edit object 122 or the company edit object 124. When integrated with an external human resources-system, termination can be performed directly from the external human resources system and trigger the system termination process. Upon the termination event, a determinate is made, in block 126, as to whether the terminated employee has any equity position that may be dependent upon employment as a precondition. If there are no equity positions requiring attention, then the employee termination process is completed in block 128 by removing the employee from database 130 (database 33 in FIG. 1) in blocks 129. If there are equity positions to resolve, then several options are presented in block 132. The first option is to choose to take no action and continue to allow the equity position of the terminated employee to travel its course despite the termination event in block 134. The second option is to change or accelerate vesting, ownership, voting rights, or any other right and/or restriction associated with the equity position in block 136. The third option is to cancel the equity position of the terminated employee in block 138. Upon choosing the equity position action, the employee is removed and its associated data updated in database 130.

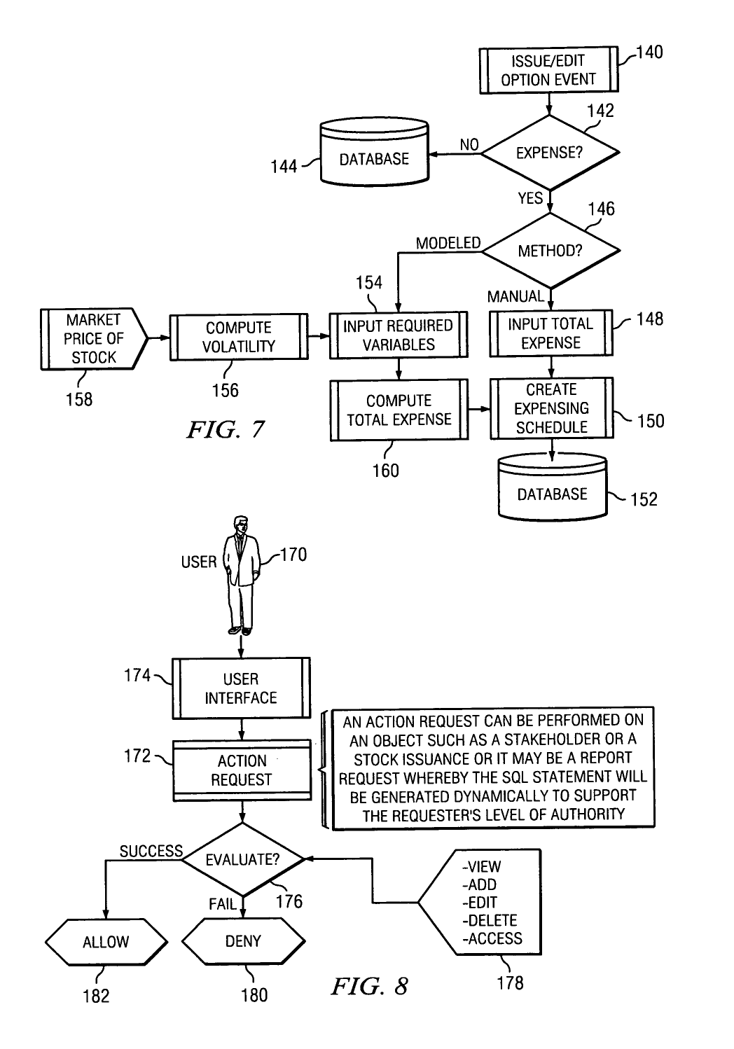

FIG. 7 is a simplified message flow diagram of an embodiment of a process for option expensing. System 10 supports the ability to generate fair value for issued stock options utilizing commonly accepted Financial Accounting Standards Board (FASB) methods for computing fair value, such as Black-Scholes, Binomial, and other suitable models. When an option is issued or edited for a stakeholder in block 140, the user with the proper authorization may compute, store, and create a vesting-based fair-value option expensing schedule. From the option configuration screen, either during issuance or any point thereafter, if the user does not want to compute and track option expensing in block 142, the user is not required to do so, and the database 144 is updated with the changes. If the user does wish to compute and schedule option expensing, a computation method is selected in block 146. If the manual computation method is selected, the user is prompted to enter a pre-computed dollar value for expense tracking in block 148. An expensing schedule is then created in block 150, and the database 152 is updated accordingly with the expensing schedule and related variable values. If the user selects a modeled method of computation in block 146, then the user is prompted to enter the appropriate values as required by the selected modeling method in block 154. One of the required values or variables, volatility, may be computed by system 10 in block 156 using known and accepted standard FASB methods. The end-of-period market price for the company's equity is used to compute the volatility in block 158. The total expense value is computed in block 160. Once all the required values are computed or entered, system 10 generates the expensing schedule computed pro-rata against the vesting schedule. The percentage of total options vested for any period is the same percentage of total expense amount realized for the same period. Once the expensing schedule is computed, all variables and related schedules are stored in the database. An expensing value for each relative period is stored as a separate record allowing retroactive and forward-looking, period-based reporting and analysis to occur.

FIG. 8 is a simplified message flow diagram of an embodiment of a process for managing security and authorizing access. When a user 170 performs an action request 172 via user interface 30 or web-based under interface 32 (FIG. 1), system 10 evaluates the action request in block 176. An action request may be performed on an object such as a stakeholder object, a stock issuance object, or it may be a request for a report, for example. The evaluation is performed against a security fabric in block 178, which establishes the permitted or authorized actions for a particular object for that particular user. The permitted actions or attributes may include view, add, edit, delete, and access control rights. These security attributes may be inherited from parent objects to child objects. If a user has more restrictive rights to a child object than it does to its parent object, then the more restrictive rights prevail when the user attempts to perform an action request on the child object, and the less restrictive rights prevail when the user attempts to perform an action on the parent object. Security in inherited through the parent-child chain until it is changed, and that changed security is inherited further down the chain. If the user's authorized actions do not permit the requested action, then the requested action fails in block 180. If the user's authorized actions permit the requested action, then the user is permitted to proceed with the requested action in block 182.

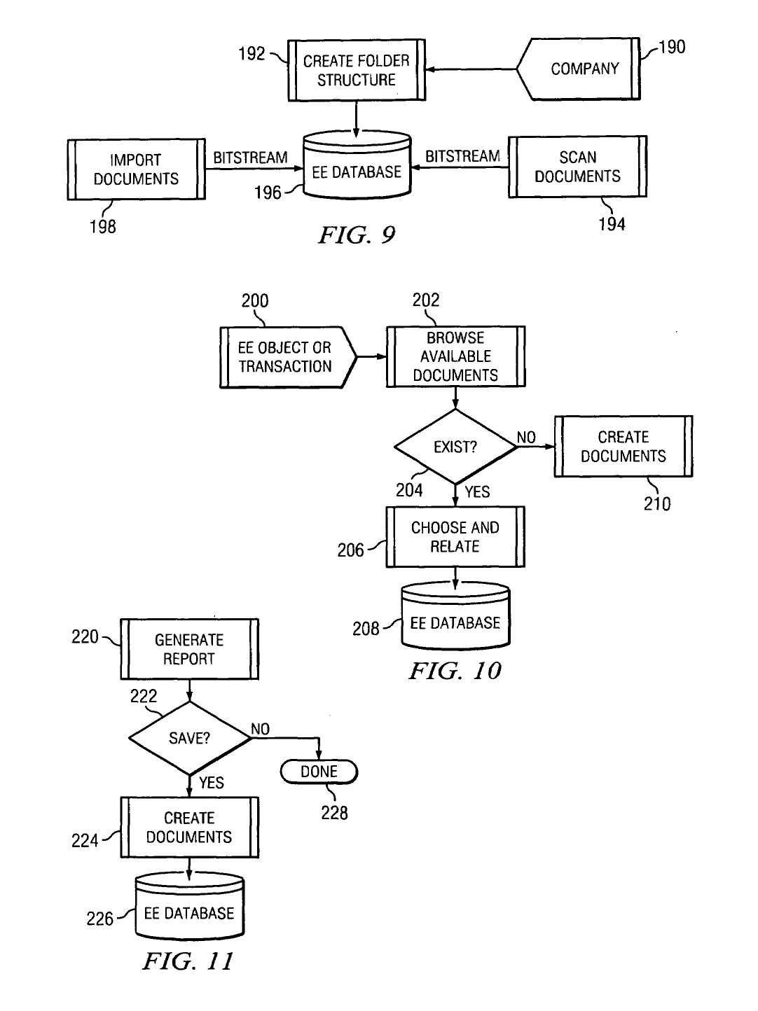

FIG. 9 is a simplified message flow diagram of an embodiment of a process for introducing, storing, managing, and annotating documents. System 10 includes a document management system that is able to store, retrieve, display, annotate, and administer documents related to the company entities and related objects. Under a defined company entity in 190 in the hierarchical tree structure view, the user creates a logical folder structure 192 which may include nested folders to hold documents. Company documents such as articles of incorporation, partnership agreements, by-laws, board minutes, historic documents, stock option plans, stock certificates, buy/sell agreements, contracts with company officers and board members. Documents may be scanned 194 and stored in database 196, or they may be imported 198. An imported document may be stored in its native document format such as MS WORD or ADOBE ACROBAT Portable Document Format (PDF), for example. A scanned document may be stored in tagged image file (TIF) format, Joint Photographic Expert Group (JPEG) format, or other supported formats.

FIG. 10 is a simplified message flow diagram of an embodiment of a process for. relating documents. Once a document is stored in the database, it may be related to objects (company object, authorization object, allocation object, issuance object, or stakeholder object) and transactions. From within an object or transaction 200, a user may brose stored documents that they are authorized to view 202. If the document the user is looking for is found, 204, then the user may select and relate it to the current object or transaction 206. When a document is related to an object or transaction, the information window of that object or transaction would include a link to the document under the document tab. Therefore, a user may easily identify and verify the document supporting the object or transaction. If the document is not yet available in the database, the document is created 210 by scanning or importing it as shown in FIG. 9.

FIG. 11 is a simplified message flow diagram of an embodiment of a process for storing reports output in the document management system. When a user generates a report 220 using system 10, the report may be stored 222 in the database of system 10 for future reference. A document is created 224 to store the report as a document in the database 226. The user may also relate the document to an object or transaction. If the user does not want to store the report output, the process completes 228.

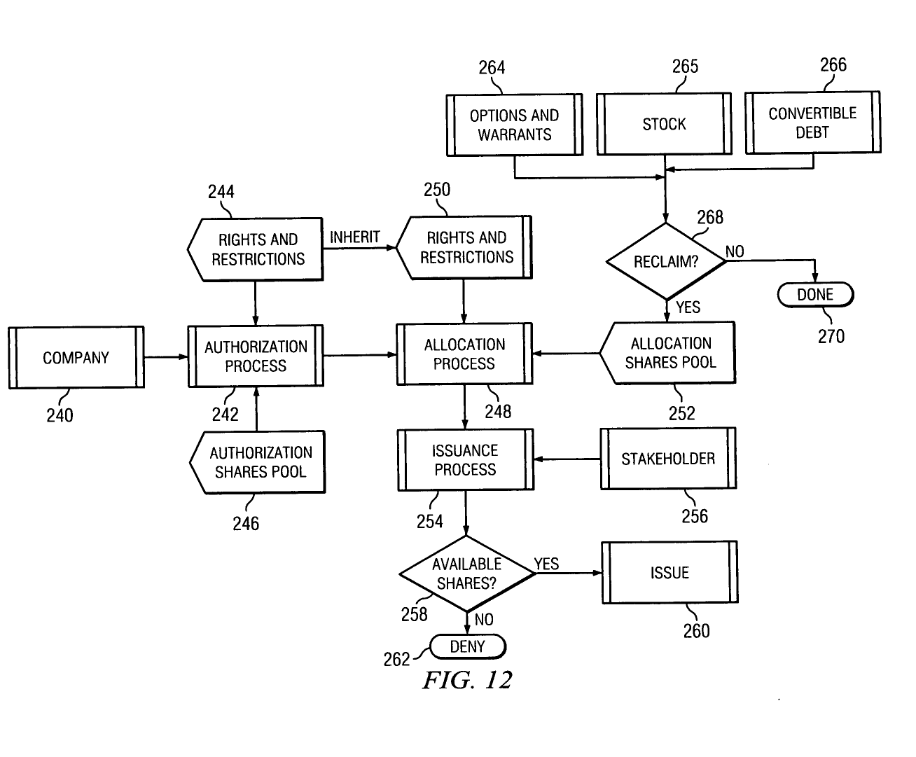

FIG. 12 is a simplified flow diagram of an embodiment of a process for issuance processing, specifically the use of allocation pools. This process avoids or reduces the chances of over-issuing equity instruments. As a part of establishing an allocation, a limit on quantities of the instruments available for issues is established, and this quantity limit is observed when instruments are issued and reclaimed. In order to perform an equity issuance, a company entity 240, when defined, is created as a company object according to object-oriented programming principles. An authorization process 242 creates one or more authorizations as a child object to a company object and may inherit characteristics or rules of the respective company object. The authorization is created with a definition of relevant equity instrument class designations, rights and restriction attributes, and the quantity of shares. The quantity of shares available may be thought of as a pool of shares 246 available for allocation. An allocation process 248 creates one or more allocations as a child object of an authorization object. The allocation includes inheriting and modifying rights and restrictions 250 from the parent authorization entity and establishing a sub-quantity or pool of shares 252 to make available to the allocation. This sub-quantity of shares 252 is the maximum number of outstanding equity instruments (stock, options, warrants, or convertible debt) that is available for issuance. The sub-quantity of shares may be up to the total available authorization share pool quantity 246 which are not allotted to other allocations. Once the allocation is established, issuances 254 to one or more stakeholders 256 may be performed. Issuance objects are created as child objects of an allocation object and inherits characteristics or rules of the allocation object. In response to an issuance request, if there are shares allocated that are available, as determined in block 258, then the shares are issued in block 260. Otherwise, the issuance request is denied in block 262.

As equity instruments 264-266 are reclaimed 268, they may be added back to the allocation shares pool 252. If the shares are re-introduced into the pool, they are available for future issuances as needed. Whether the reclaimed equity instruments are added back to the pool depends on how the authorization and the allocation rules and attributes were configured. If they are not reclaimed, then the reclaim process is done in block 270.

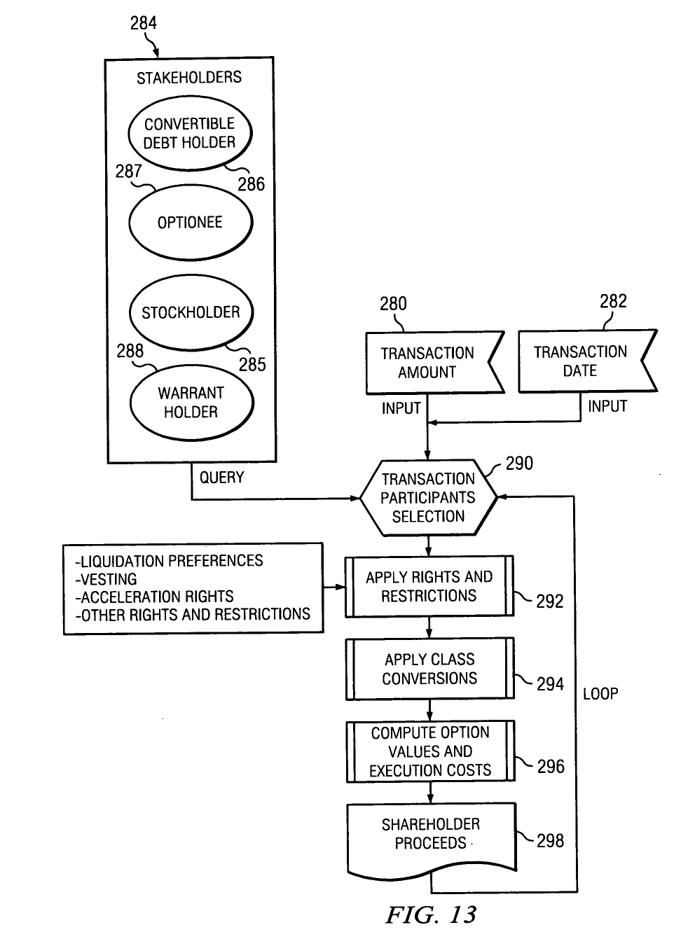

FIG. 13 is a simplified flow diagram of an embodiment of a process for analyzing liquidation proceeds. The ability to assess proceeds due to stakeholders in the event of a future liquidation transaction involves applying many of the data elements captured as a part of the entire equity administration and issuance process. The analysis process includes the ability to perform “what-if” modeling against those data elements and existing stakeholder positions such as which stakeholders might be eligible to participate, and what happens if they were to surrender their rights prior to the liquidation event.

In order to perform the liquidation proceeds analysis, the user enters a project transaction amount 280, and a projected transaction date 282. System 10 then presents the user with a list of stakeholders 284, including valid stockholders 285, convertible debt holders 286, optionees 287, and warrant holders 288 for selection 290. Stakeholders of futures such as options and warrants require system 10 to project future vesting through the transaction data in order to determine the quantity of shares that will have vested by the transaction date and thus will be subject to pro-rata distribution of proceeds. The list of possible participant stakeholders is presented to the user to select stakeholders that will participate in the liquidation event. Once the list of stakeholder participants is selected, system 10 processes the list by applying all relevant rights and restrictions 292, such as liquidation preferences, any future vesting which will occur, acceleration of vesting rights or other rights and restrictions which would affect the participation and liquidation payout. System 10 also applies any applicable class conversion 294 to normalize all shares to the lowest common denominator, for example, common stock. System 10 then computes, for each option and warrant, any amounts due and payable 296 in order to execute (strike price) and imputes liquidation value per share to determine if each option and warrant has value. The computed result is then presented to the user in the form of a report 298. The user may view, print, and export the report. The user is then given the opportunity to return to the selection of participant stakeholders 290 to assess additional “what-if” scenarios using a different set of stakeholders. The user may also choose to return to blocks 280 and/or 282 to enter different transaction amounts and/or transaction dates to further analyze other “what-if” scenarios.

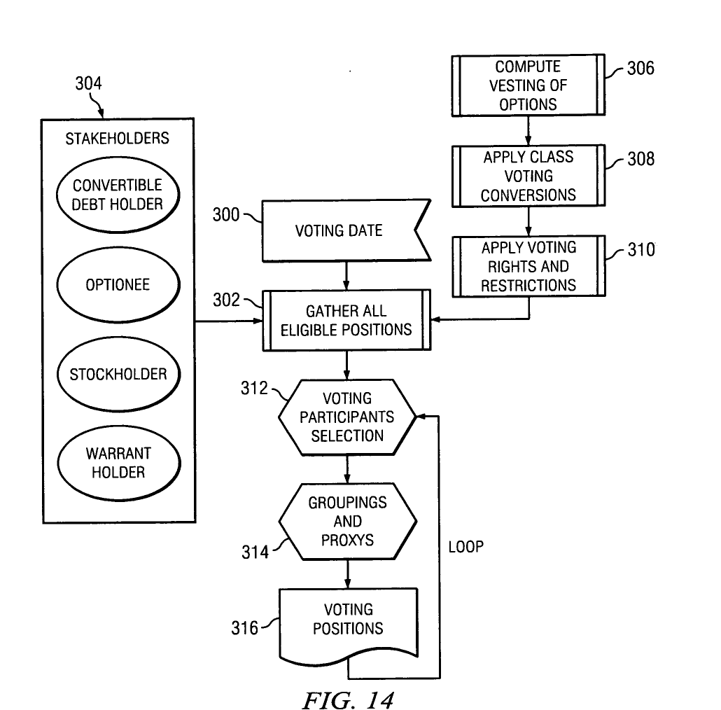

FIG. 14 is a flow diagram of an embodiment of a method to analyze stakeholder voting rights. The user is first prompted to enter a voting date 300, which may be any date from the present date to a future date. System 10 then retrieves all eligible issuance positions 302 of stakeholders 304 in the system. For those issuance positions which are future or involve vesting such as options, vested stock, or warrants, the system projects forward those events that would cause the issuance to potentially convert to a voting instrument 306. This may include, but is not limited to, applying all future vesting events through the voting date. Therefore, this analysis may include the potential of an optionee, for example, exercising their entire eligible position to become a voting shareholder on the day of the vote. System 10 then applies any class voting conversions that are applicable 308. Class conversions may cause a class of stock to vote in accordance with an accelerated ratio to other classes of stock such as 5:1. The system then applies any remaining voting rights and restrictions such as eliminating stocks that are “non-voting” 310 to produce a list of all stakeholders and their voting eligibility including computed maximum votes 302. The user may then select those stakeholders they anticipate will participate in the voting event 312. The user is also given the ability and opportunity to group stakeholders to better understand how certain factions will vote 314. A result of voting positions which may include a list of participating shareholders with their computed votes grouped together is then generated 316. The user may choose to return to blocks 312 and 314 to select a different set of participants to consider other voting scenarios. The result may be viewed online, printed, and exported.

1. A digital computer programmed with a set of function modules for administering company entities, records, documents, equity instruments and stakeholders comprising:
an equity management module operable to create an authorization pool of a predetermined number of authorizations for a company, creating an allocation pool of a predetermined number of allocations for the authorization, and issuing a predetermined number of shares of equity from the allocation pool to a stakeholder,
wherein the equity management module is further operable to define rights and restrictions of the authorization, inheritance of the rights and restrictions of the allocation from the rights and restrictions of the authorization, and inheritance of the rights and restrictions of the issuance from the rights and restrictions of the allocation;
a liquidation module operable to determine what amount is due and payable to the stakeholders upon a liquidation event;
wherein the liquidation module is operable to receive a selection of participating stakeholders;
a voting rights analysis module operable to generate a report on voting positions in response to a selection of voting data and a selection of participating stakeholders; and,
wherein the voting rights analysis module is operable to compute vesting of options, apply class voting conversions, and apply voting rights and restrictions to the selected participating stakeholders' equity.

2. The digital computer of claim 1, wherein the equity management module is further operable to reclaim issued equity and adding the reclaimed equity back to the allocation pool.

3. The digital computer of claim 1, wherein the liquidation module is operable to apply rights and restrictions of the equity instruments of selected participating stakeholders.

4. The digital computer of claim 1, wherein the liquidation module is operable to apply class conversions of the equity instruments of selected participating stakeholders.

5. The digital computer of claim 1, wherein the liquidation module is operable to set the liquidation event at a date entered by the user.
